(19) United States
(12) Patent Application Publication
(10) Pub. No.: US 2015/0059505 A1
(43) Pub. Date: Mar. 5, 2015

(54) Gearbox

(71) Applicant: SHIROKI CORPORATION, Fujisawa-shi, Kanagawa (JP)

(72) Inventor: Tomohiro Enokijima, Fujisawa-shi (JP)

(21) Appl. No.: 14/388,194

(22) PCT Filed: Mar. 8, 2013
(86) PCT No.: PCT/JP2013/056455

§ 371 Date: Sep. 25, 2014

(30) Foreign Application Priority Data
Mar. 28, 2012 (JP) 2012-073130

(51) Int. Cl. F16H 57/039; F16H 57/032; F16H 1/16

(52) U.S. Cl. CPC F16H 57/039; F16H 1/16; F16H 57/032; F16H 2057/02008
USPC 74/416

(57) ABSTRACT

A gearbox includes: a first shaft having a first gear; a second shaft arranged to intersect with the first shaft and having a second gear configured to mesh with the first gear; a pair of first cases arranged to interpose the first gear therebetween from an axial direction and formed with holes into which the first shaft is inserted; a pair of second cases arranged to interpose the second gear therebetween from an axial direction and formed with holes into which the second shaft is inserted, and a pressing mechanism in which the second cases, in response to pressing in a direction toward the first cases press, press the pair of the first cases to each other.

### TECHNICAL FIELD

The present invention relates to a gearbox including a first shaft having a first gear, a second shaft arranged to intersect with the first shaft and having a second gear configured to mesh with the first gear and a first case configured to rotatably support the first shaft.

### BACKGROUND ART

A description is made with reference to FIG. 15. FIG. 15 is an exploded perspective view of a gearbox embedded in a seat track according to the background art. In FIG. 15, a drive shaft (a first shaft) 1 configured to rotate by a motor provided for an upper rail (not shown) has a worm (a first gear: drive gear) 3.

A fixed shaft 5 is arranged to intersect with the drive shaft 1. Both end portions of the fixed shaft 5 are supported at a state where rotations thereof are locked by shaft holders 13 provided for a lower rail. A circumferential surface of the fixed shaft 5 is formed with a male screw.

The fixed shaft 5 is provided with a cylindrical nut member 7. The nut member 7 is formed on its inner peripheral part with a female screw configured to screw with the male screw of the fixed shaft 5. The nut member 7 functions as a driven shaft (a second shaft). The nut member 7 is formed on its outer peripheral part with a worm wheel (a second gear: driven gear) configured to mesh with the worm 3.

A pair of cases 9, 11 is arranged to interpose the worm 3 therebetween from an axial direction. Surfaces 9d, 11d of the cases 9, 11 intersecting with the drive shaft 1 are formed with holes 9a, 11a into which the drive shaft 1 is inserted. Also, one surface 9e and one surface 11 e orthogonal to the surface 9d of the case 9 and the surface 11d of the case 11 are formed with semi-circular recess portions 9b, 11b configured to cooperatively hold one side of the outer peripheral part of the nut member 7. Further, the other surface 9f and the other surface 11f orthogonal to the surface 9d of the case 9 and the surface 11d of the case 11 are formed with semi-circular recess portions 9c, 11c (the recess portion 9c is not shown) configured to cooperatively hold the other side of the outer peripheral part of the nut member 7.

The drive shaft 1, the nut member (driven shaft) 7, the case 9 and the case 11 are integrated using screws 14, 15, thereby configuring a gearbox 2. The gearbox 2 is attached to the upper rail by using a bracket 17.

### CITATION LIST

### Patent Literature

[Patent Literature 1] Japanese Patent Application Publication No. 2007-513005A

### SUMMARY OF THE INVENTION

### Technical Problem

However, the gearbox having the above configuration is integrated with using the screws 14, 15. Therefore, there is a problem of requiring an effort for assembling.

It is therefore an object of the present invention to provide a gearbox not requiring an effort to assemble the gearbox.

### Solution to Problem

In order realize at least one of the problems, a gearbox reflecting one aspect of the present invention includes A gearbox includes: a first shaft having a first gear; a second shaft arranged to intersect with the first shaft and having a second gear configured to mesh with the first gear; a pair of first cases arranged to interpose the first gear therebetween from an axial direction and formed with holes into which the first shaft is inserted; a pair of second cases arranged to interpose the second gear therebetween from an axial direction and formed with holes into which the second shaft is inserted, and a pressing mechanism in which the second cases, in response to pressing in a direction toward the first cases, press the pair of the first cases to each other.

### Effects of the Present Invention

According to the present invention, the gearbox includes the pair of second cases arranged to interpose the second gear therebetween from the axial direction and formed with the holes into which the second shaft is inserted, and the pressing mechanism configured to push the pair of the first cases to each other when the second cases are pressed in the direction toward the first cases. Thereby, the man-hour for assembling a component for which a mechanical coupling such as a screw is performed is not necessary. Therefore, a gearbox not requiring an effort for assembling is provided.

### BRIEF DESCRIPTION OF THE DRAWINGS

FIG. 1 is an exploded perspective view of a gearbox according to a first illustrative embodiment.

FIG. 2 is a perspective view of one first case of a pair of first cases shown in FIG. 1.

FIG. 3 is a perspective view of one second case of a pair of second cases shown in FIG. 1.

FIGS. 4A-4D illustrate a process of assembling the gearbox shown in FIG. 1.

FIG. 5 illustrates a process of assembling the gearbox shown in FIG. 1.

FIG. 6 is a schematic view illustrating a pressing mechanism.

FIG. 7 is an enlarged view of an A part of FIG. 6, illustrating an inclined angle of an inclined surface.

FIG. 8 illustrates a modified embodiment of the first illustrative embodiment.

FIG. 9 is a schematic view illustrating a pressing mechanism of a gearbox according to a second illustrative embodiment.

FIG. 10 is a schematic view illustrating a pressing mechanism of a gearbox according to a third illustrative embodiment.

FIG. 11 is a schematic view illustrating a pressing mechanism of a gearbox according to a fourth illustrative embodiment.

FIG. 12 is a schematic view illustrating a pressing mechanism of a gearbox according to a fifth illustrative embodiment.

FIG. 13 is a schematic view illustrating a pressing mechanism of a gearbox according to a sixth illustrative embodiment.

FIG. 14 is a schematic view illustrating a pressing mechanism of a gearbox according to a seventh illustrative embodiment.

FIG. 15 is an exploded perspective view of a gearbox embedded in a seat track according to the background art.

### DESCRIPTION OF ILLUSTRATIVE EMBODIMENTS

### First Illustrative Embodiment

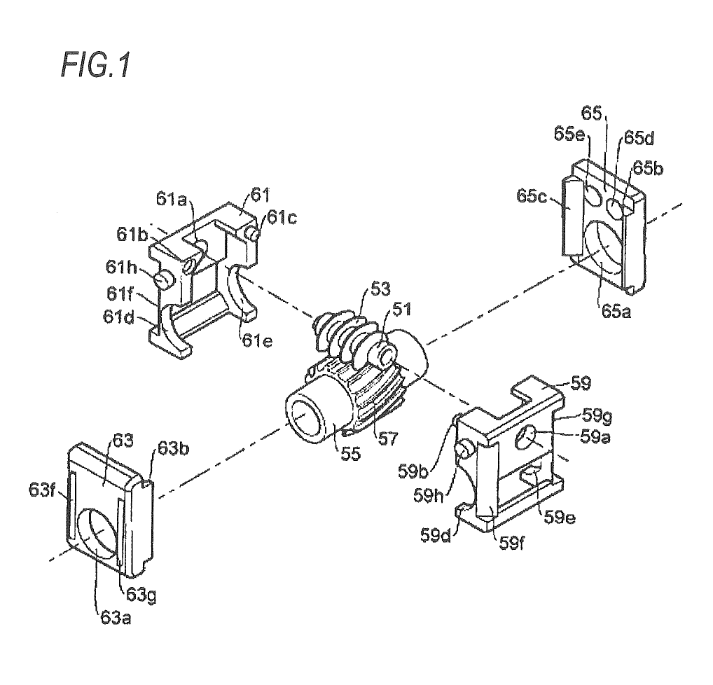

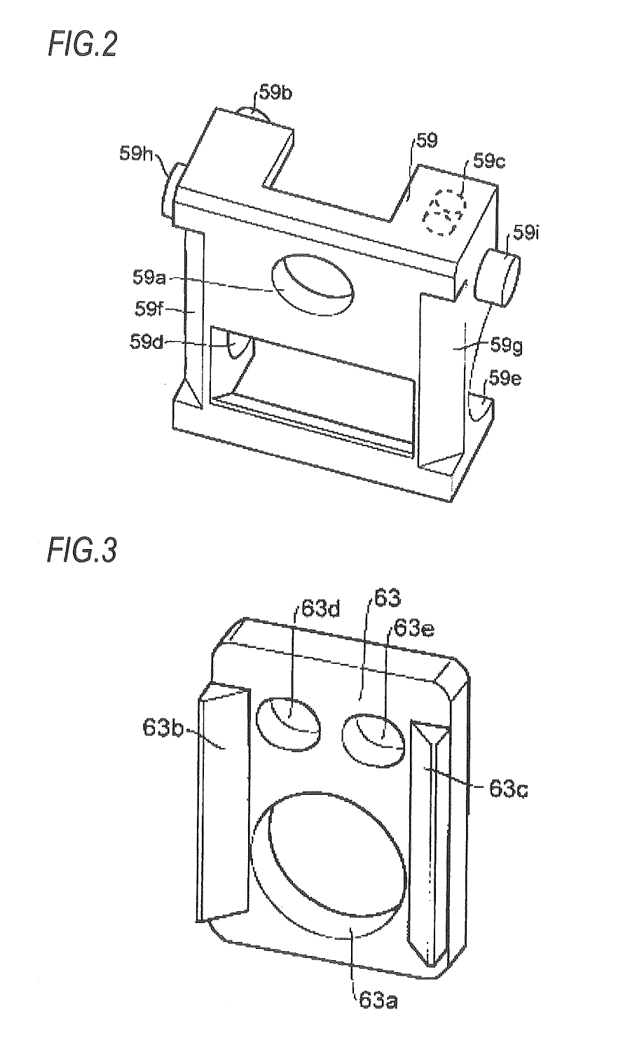

A gearbox according to a first illustrative embodiment will be described with reference to FIGS. 1 to 3. FIG. 1 is an exploded perspective view of a gearbox according to a first illustrative embodiment, FIG. 2 is a perspective view of one first case of a pair of first cases shown in FIG. 1 and FIG. 3 is a perspective view of one second case of a pair of second cases shown in FIG. 1.

In FIG. 1, a drive shaft (a first shaft) 51 is provided with a worm (a first gear) 53.

A driven shaft (a second shaft) 55 orthogonal to (intersecting with) the drive shaft 51 is provided with a worm wheel 57 configured to mesh with the worm 53 of the drive shaft 51.

A pair of first cases 59, 61 is arranged to interpose the worm 53 therebetween from an axial direction. The first case 59 and the first case 61 are formed with holes 59a, 61a in which the drive shaft 51 is inserted and is rotatably supported.

A pair of second cases 63, 65 is arranged to interpose the worm wheel 57 therebetween from an axial direction. The second case 63 and the second case 65 are formed with a hole 63a and a hole 65a in which the driven shaft 55 is inserted and is supported.

Meanwhile, in this illustrative embodiment, a degree of elasticity of a material of the second cases 63, 65 is set to be smaller than that of a material of the first cases 59, 61. That is, the second cases 63, 65 are likely to be more easily deformable than the first cases 59, 61.

As shown in FIGS. 1 and 2, a surface of the first case 59 facing the first case 61 is formed with a protrusion 59b protruding towards the axial direction of the drive shaft 51 and a hole 59c. The protrusion 59b and the hole 59c are formed so that the hole 59a is positioned therebetween. In the meantime, a surface of the first case 61 facing the first case 59 is formed with a hole 61b into which the protrusion 59b of the first case 59 is fitted and a protrusion 61c protruding towards the axial direction of the drive shaft 51 and fitted into the hole 59c of the first case 59. The hole 61b and the protrusion 61c are formed so that the hole 61a is positioned therebetween. In the meantime, the fitting of the protrusion 59b and the hole 61b and the fitting of the protrusion 61c and the hole 59c are loose fittings. For this reason, the fittings are not to fix the first case 59 and the first case 61 each other but to temporarily position the same.

The surface of the first case 59 facing the first case 61 is formed at its lower part with semi-cylindrical recess portions 59d, 59e configured to interpose and support the driven shaft 55 from one side thereof. In the meantime, the surface of the first case 61 facing the first case 59 is formed at its lower part with semi-cylindrical recess portions 61d, 61e configured to interpose and support the driven shaft 55 from the other side thereof.

The first case 59 is formed with a chamfered surface (an inclined surface) 59f and a chamfered surface 59g at vertical corner parts of sides of a back surface thereof. Likewise, the first case 61 is formed with a chamfered surface (an inclined surface) 61f and a chamfered surface 61g (the chamfered surface 61g is not shown) at vertical corner parts of sides of a back surface thereof.

The first case 59 is formed at upper parts of side surfaces thereof with protrusions 59h, 59i protruding towards the axial direction of the driven shaft 55. Likewise, the first case 61 is formed at upper parts of side surfaces thereof with protrusions 61h, 61i (the protrusion 61i is not shown) protruding towards the axial direction of the driven shaft 55.

Further, a surface (an outer surface) of the second case 63 opposite to the surface thereof facing the second case 65 is formed with a bead (a rib) 63f and a bead (a rib) 63g so that an opening of the hole 63a is interposed therebetween. Likewise, a surface (an outer surface) of the second case 65 opposite to the surface thereof facing the second case 63 is also formed with a bead (a rib) 65f (not shown) and a bead (a rib) 63g (not shown) so that an opening of the hole 65a is interposed therebetween.

As shown in FIGS. 1 and 3, the surface of the second case 63 facing the second case 65 is formed at its sides with an inclined surface 63b configured to abut on the inclined surface 59f of the first case 59 and an inclined surface 63c configured to abut on the inclined surface 61f of the first case 61. Likewise, the surface of the second case 65 facing the second case 63 is formed at its sides with an inclined surface 65b configured to abut on the inclined surface 59g of the first case 59 and an inclined surface 65c configured to abut on the inclined surface 61g of the first case 61.

When the second case 63 and the second case 65 are pressed in the direction of the first case 59 and the first case 61, the inclined surface 63b and inclined surface 63c of the second case 63 press the inclined surface 59f of the first case 59 and the inclined surface 61f of the first case 61, respectively. Also, the inclined surface 65b and inclined surface 65c of the second case 65 press the inclined surface 59g of the first case 59 and the inclined surface 61g of the first case 61, respectively. Thereby, the pair of first cases 59, 61 is pushed to each other by force components of forces generated on the inclined surface 63b and inclined surface 63c of the second case 63 and the inclined surface 65b and inclined surface 65c of the second case 65. That is, the inclined surface 63b and inclined surface 63c of the second case 63 and the inclined surface 65b and inclined surface 65c of the second case 65 function as pressing mechanisms that are pressing force generation surfaces from which the force components of pushing the pair of first cases 59, 61 to each other are generated when the second case 63 and the second case 65 are pressed in the direction of the first case 59 and the first case 61.

The surface of the second case 63 facing the second case 65 is formed at its upper part with a hole 63d in which the protrusion 59h of the first case 59 is fitted and a hole 63e in which the protrusion 61h of the first case 61 is fitted. Likewise, the surface of the second case 65 facing the second case 63 is formed at its upper part with a hole 65d in which the protrusion 59i of the first case 59 is fitted and a hole 65e in which the protrusion 61i of the first case 61 is fitted. In the meantime, the fitting of the protrusion 59h and the hole 63d, the fitting of the protrusion 61h and the hole 63e, the fitting of the protrusion 59i and the hole 65d and the fitting of the protrusion 61i and the hole 65e are to enable the first case 59 and the first case 61 to move in the pushing direction when the second case 63 and the second case 65 are pressed in the direction of the first case 59 and first case 61 and the pair of first cased 59, 61 is thus pushed to each other.

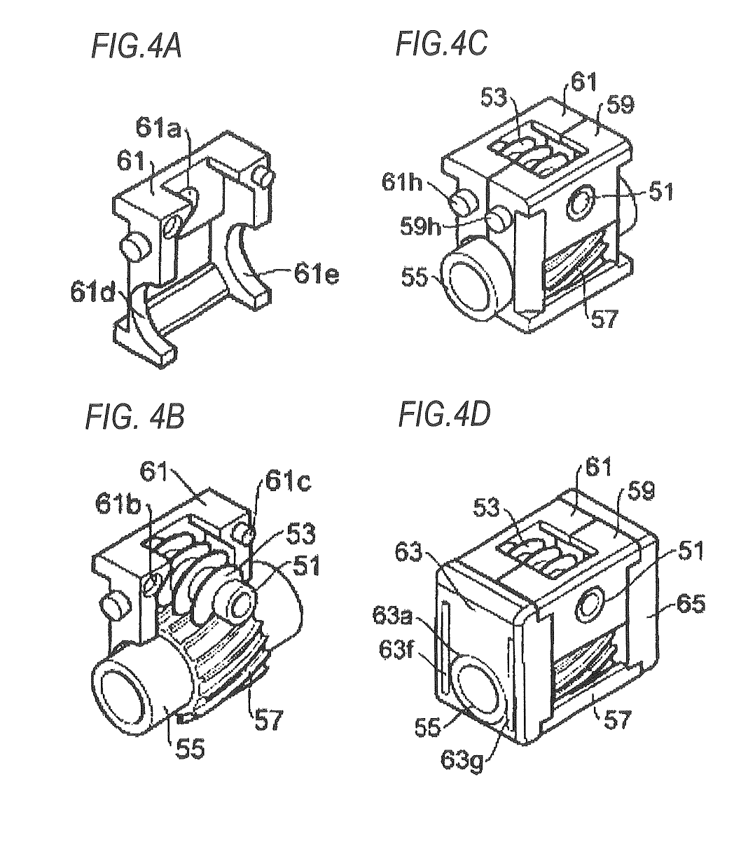

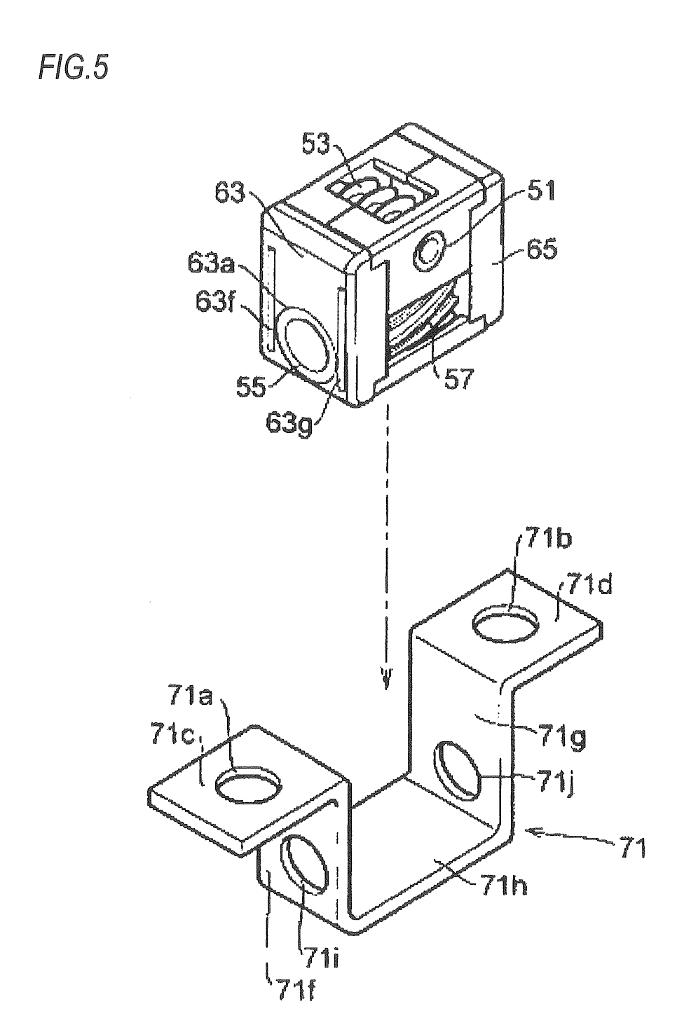

Subsequently, a method of assembling the gearbox having the above configuration is described with reference to FIGS. 4 and 5. FIGS. 4 and 5 illustrate a method of assembling the gearbox shown in FIG. 1.

First of all, as shown in FIGS. 4A and 4B, the drive shaft 51 having the worm 53 is inserted into the hole 61a of the first case 61. Also, one side of the driven shaft 55 having the worm wheel 57 is supported to the semi-cylindrical recess portions 61d, 61e of the first case 61.

Then, as shown in FIG. 4C, the first case 59 is assembled to the first case 61. At this time, the protrusion 61c of the first case 61 is loosely fitted into the hole 59c of the first case 59 and the protrusion 59b of the first case 59 is loosely fitted into the hole 61b of the first case 61. Thereby, the first case 61 and the first case 59 are temporarily positioned. Also, the drive shaft 51 is inserted into the hole 59a of the first case 59. Further, the other side of the driven shaft 55 having the worm wheel 57 is supported to the semi-cylindrical recess portions 59d, 59e of the first case 59.

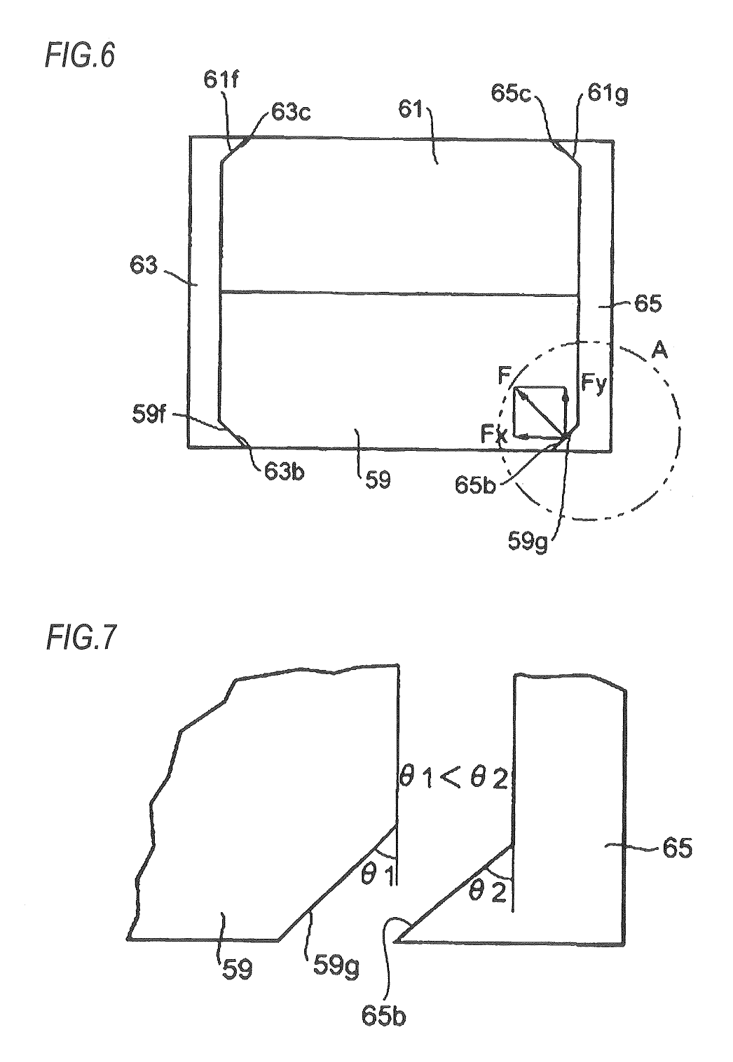

Then, as shown in FIG. 4D, the second case 63 and the second case 65 are assembled. At this time, as shown in FIG. 6, the inclined surface 63b of the second case 63 abuts on the inclined surface 59f of the first case 59. The inclined surface 63c of the second case 63 abuts on the inclined surface 61f of the first case 61. Also, the inclined surface 65b of the second case 65 abuts on the inclined surface 59g of the first case 59. The inclined surface 65c of the second case 65 abuts on the inclined surface 61g of the first case 61.

Also, the protrusion 59h of the first case 59 is loosely fitted into the hole 63d of the second case 63, the protrusion 61h of the first case 61 is loosely fitted into the hole 63e of the second case 63, the protrusion 59i of the first case 59 is loosely fitted into the hole 65d of the second case 65 and the protrusion 61i of the first case 61 is loosely fitted into the hole 65e of the second case 65.

At this time, at least one of the first case 59 and first case 61 and the second case 63 and second case 65 is elastically deformed by the pressing force of the pressing mechanisms. Static friction between the first cases 59, 61 and the second cases 63, 65, which is generated by an elastically repulsive force thereof, keeps the assembled state of the first cases 59, 61 and the second cases 63, 65.

Finally, as shown in FIG. 5, the assembling-completed gearbox is assembled to a bracket 71. The bracket 71 has a base part 71c, a base part 71d, an upstanding wall part 71f, an upstanding wall part 71g and a bottom part 71h. The base part 71c and the base part 71d are formed with holes 71a, 71b for upper rail assembling.

The upstanding wall part 71f is bent from an end portion of the base part 71c at the base part 71d-side and is configured to face the second case 63 of the gearbox. Also, the upstanding wall part 71f is formed with a hole 71i facing the hole 63a of the second case 63.

The upstanding wall part 71g is bent from an end portion of the base part 71d at the base part 71c-side and is configured to face the second case 65 of the gearbox. Also, the upstanding wall part 71g is formed with a hole 71j facing the hole 65a of the second case 65.

The bottom part 71h is configured to bridge lower end portions of the upstanding wall part 71f and the upstanding wall part 71g and to face a bottom part of the gearbox.

When the gearbox is assembled to a space surrounded by the upstanding wall part 71f, upstanding wall part 71g and bottom part 71h of the bracket 71, the bead 63f and bead 63g of the second case 63 and the bead 65f and bead 65g of the second case 65 are elastically deformed and the second case 63 and the second case 65 are pressed in the direction of the first case 59 and the first case 61.

Here, the pressing mechanism is described with reference to FIGS. 6 and 7. FIG. 6 is a schematic view illustrating the pressing mechanism, and FIG. 7 is an enlarged view of an A part of FIG. 6, illustrating an inclined angle of the inclined surface.

As shown in FIG. 6, the inclined surface 63b of the second case 63 presses the inclined surface 59f of the first case 59, and the inclined surface 63c of the second case 63 presses the inclined surface 61f of the first case 61. Also, the inclined surface 65b of the second case 65 presses the inclined surface 59g of the first case 59, and the inclined surface 65c of the second case 65 presses the inclined surface 61g of the first case 61.

Here, in this illustrative embodiment, the inclined surface 59f and inclined surface 59g of the first case 59 and the inclined surface 61f and inclined surface 61g of the first case 61 have the same inclined angle. Also, the inclined surface 63b and inclined surface 63c of the second case 63 and the inclined surface 65b and inclined surface 65c of the second case 65 have the same inclined angle. As shown in FIG. 7, when the inclined angle of the inclined surfaces of the first cases 59, 61 is denoted with θ1 and the inclined angle of the inclined surfaces of the second cases 63, 65 is denoted with θ2, θ1<θ2.

By the force components of the force generated on the inclined surface 63b and inclined surface 63c of the second case 63 and the inclined surface 65b and inclined surface 65c of the second case 65, which are the pressing force generation surfaces, the pair of first cases 59, 61 is pushed to each other.

As shown in the A part of FIG. 6, a force component Fy of force components Fx, Fy of a force F generated on the inclined surface 65b, which is the pressing force generation surface, is the pressing force pushing the first case 59 and the first case 61 to each other.

According to the above configuration, since the first case 59 and the first case 61 can be integrated without using a screw, an effort is not required for the assembling.

In the meantime, the present invention is not limited to the above illustrative embodiment. In the above illustrative embodiment, when the inclined angle of the inclined surfaces of the first cases 59, 61 is denoted with θ1 and the inclined angle of the inclined surfaces of the second cases 63, 65 is denoted with θ2, θ1<θ2. However, θ1 may be equal to θ2.

Also, as shown in FIG. 8, when the inclined angle of the inclined surfaces of the first cases 59, 61 is denoted with θ1 and the inclined angle of the inclined surfaces of the second cases 63, 65 is denoted with θ2, θ1 may be larger than θ2.

In the case of θ1<θ2 shown in FIG. 7, the pressing force is greater, as compared to the case of θ1>θ2 shown in FIG. 8. However, since the greater force is applied to the inclined surfaces of the second case 63 and second case 65, the second case 63 and the second case 65 having higher strength are required.

### Second Illustrative Embodiment

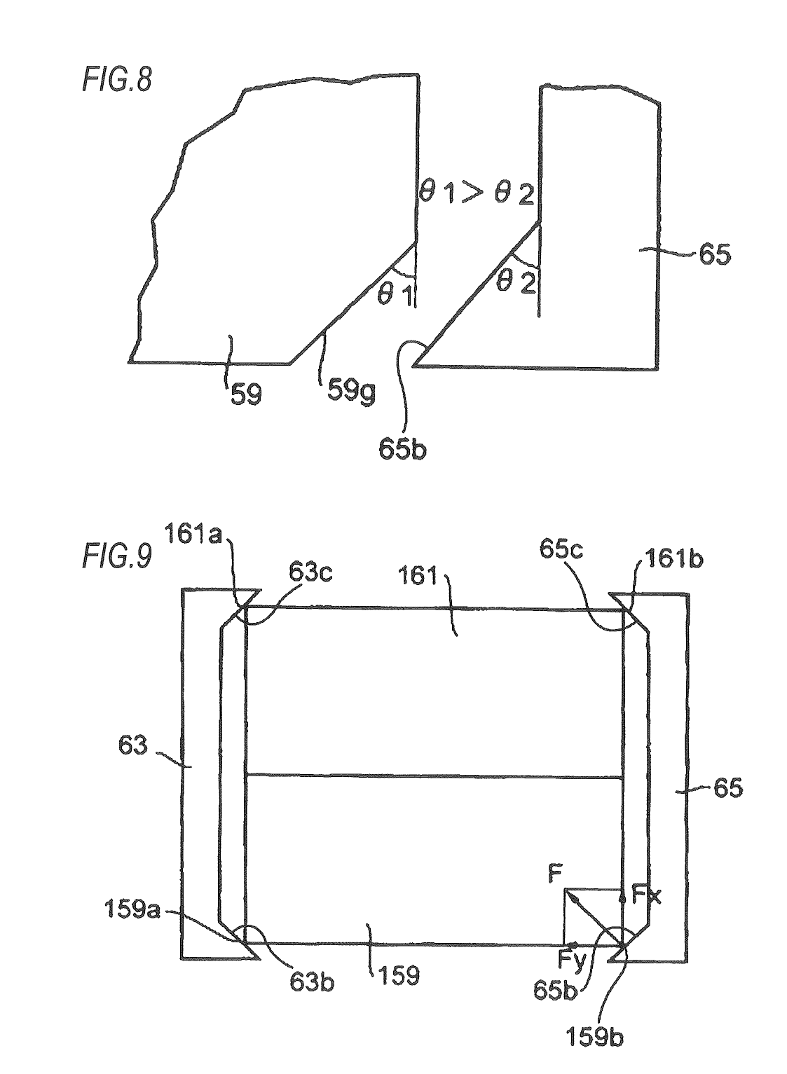

Subsequently, a gearbox according to a second illustrative embodiment is described with reference to FIG. 9. FIG. 9 is a schematic view illustrating a pressing mechanism of a gearbox according to a second illustrative embodiment.

This illustrative embodiment is different from the first illustrative embodiment as regards the first case, and the other configurations are the same. Therefore, the same parts as the first illustrative embodiment are denoted with the same reference numerals and the overlapping descriptions thereof are omitted.

When a pair of first cases 159, 161 is assembled, the first cases configure a substantial cuboid. A corner part 159a of the first case 159 is pressed to the inclined surface 63b of the second case 63 and a corner part 161a of the first case 161 is pressed to the inclined surface 63c of the second case 63. Also, a corner part 159b of the first case 159 is pressed to the inclined surface 65b of the second case 65 and a corner part 161b of the first case 161 is pressed to the inclined surface 65c of the second case 65.

By the inclined surface 63b and inclined surface 63c of the second case 63 and the inclined surface 65b and inclined surface 65c of the second case 65, which are the pressing force generation surfaces, the pair of first case 159 and first case 161 is pushed to each other.

As shown in FIG. 9, the operation is described with reference to the inclined surface 65b and the corner part 159b. A force component Fy of force components Fx, Fy of a force F generated on the inclined surface 65b, which is the pressing force generation surface, is the pressing force pushing the first case 159 and the first case 161 to each other.

According to the above configuration, since the first case 159 and the first case 161 can be integrated without using a screw, an effort is not required for the assembling.

### Third Illustrative Embodiment

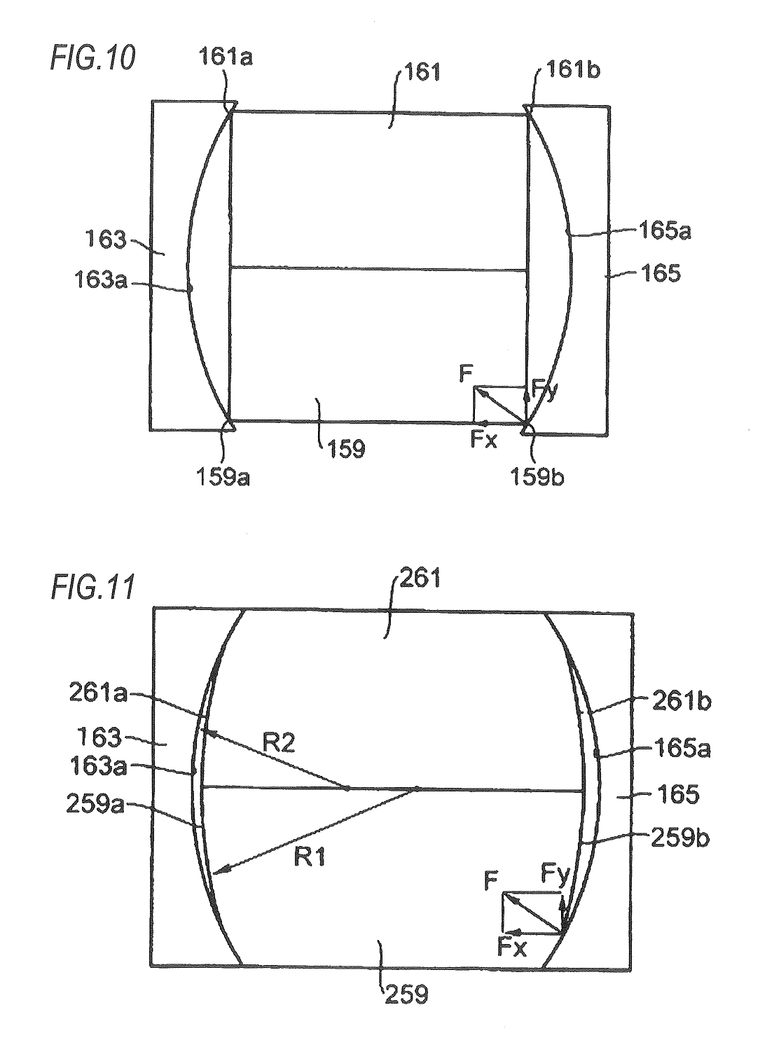

A gearbox according to a third illustrative embodiment is described with reference to FIG. 10. FIG. 10 is a schematic view illustrating a pressing mechanism of a gearbox according to a third illustrative embodiment. This illustrative embodiment is different from the second illustrative embodiment as regards the second case, and the other configurations are the same. Therefore, the same parts as the second illustrative embodiment are denoted with the same reference numerals and the overlapping descriptions thereof are omitted.

In this illustrative embodiment, the pressing force generation surfaces of the pressing mechanisms of a second case 163 and a second case 165 are a circular arc surface 163a and a circular arc surface 165a.

The corner part 159a of the first case 159 and the corner part 161a of the first case 161 are pressed by the circular arc surface 163a of the second case 163. Also, the corner part 159b of the first case 159 and the corner part 161b of the first case 161 are pressed by the circular arc surface 165a of the second case 165.

By the circular arc surface 163a of the second case 163 and the circular arc surface 165a of the second case 165, which are the pressing force generation surfaces, the pair of first cases 159, 161 is pushed to each other.

As shown in FIG. 10, the operation is described with reference to the circular arc surface 165a and the corner part 159b. A force component Fy of force components Fx, Fy of a force F generated on the circular arc surface 165a, which is the pressing force generation surface, is the pressing force pushing the first case 159 and the first case 161 to each other.

According to the above configuration, since the first case 159 and the first case 161 can be integrated without using a screw, an effort is not required for the assembling.

In the meantime, the present invention is not limited to the above illustrative embodiment. In the above illustrative embodiment, the first case 159 and the first case 161 are formed with the circular arc surfaces. However, any curved surface from which the force pushing the first case 159 and the first case 161 to each other is generated is also possible.

### Fourth Illustrative Embodiment

A gearbox according to a fourth illustrative embodiment is described with reference to FIG. 11. FIG. 11 is a schematic view illustrating a pressing mechanism of a gearbox according to a fourth illustrative embodiment. This illustrative embodiment is different from the third illustrative embodiment as regards the first case, and the other configurations are the same. Therefore, the same parts as the third illustrative embodiment are denoted with the same reference numerals and the overlapping descriptions thereof are omitted.

When a pair of first cases 259, 261 is assembled, the first cases configure a box shape having a circular arc surface of which a facing surface 259a and a facing surface 261a towards the second case 163 are continuous and a circular arc surface of which a facing surface 259b and a facing surface 261b towards the second case 165 are continuous.

A radius of the circular arc surface having the facing surface 259a and facing surface 259b of the first case 259 and a radius of the circular arc surface having the facing surface 261a and facing surface 261b of the first case 261 are the same, i.e., R1. In the meantime, a radius of the circular arc surface 163a of the second case 163 and a radius of the circular arc surface 165a of the second case 165 are the same, i.e., R2. Here, R1>R2.

An outer end portion of the facing surface 259a of the first case 259 and an outer end portion of the facing surface 261a of the first case 261 are pressed to the circular arc surface 163a of the second case 163, and an outer end portion of the facing surface 259b of the first case 259 and an outer end portion of the facing surface 261b of the first case 261 are pressed to the circular arc surface 165a of the second case 165.

By the circular arc surface 163a of the second case 163 and the circular arc surface 165a of the second case 165, which are the pressing force generation surfaces, the pair of first cases 259, 261 is pushed to each other.

As shown in FIG. 11, the operation is described with reference to the circular arc surface 165a and the outer end portion of the facing surface 259b. A force component Fy of force components Fx, Fy of a force F generated on the circular arc surface 165a, which is the pressing force generation surface, is the pressing force pushing the first case 259 and the first case 261 to each other.

According to the above configuration, since the first case 259 and the first case 261 can be integrated without using a screw, an effort is not required for the assembling.

### Fifth Illustrative Embodiment

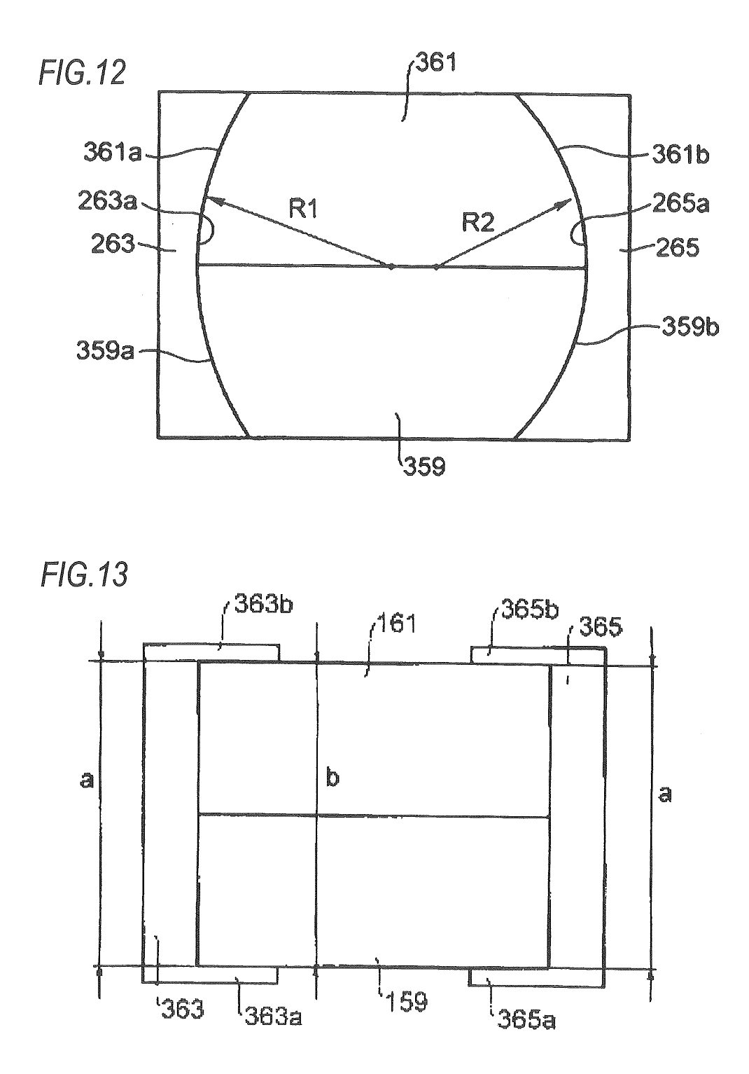

A gearbox according to a fifth illustrative embodiment is described with reference to FIG. 12. FIG. 12 is a schematic view illustrating a pressing mechanism of a gearbox according to a fifth illustrative embodiment.

In this illustrative embodiment, a second case 263 is formed with a circular arc surface 263a and a second surface 265 is formed with a circular arc surface 265a.

When a pair of first cases 359, 361 is assembled, the first cases configure a box shape having a circular arc surface of which a facing surface 359a and a facing surface 361a towards the second case 263 are continuous and a circular arc surface of which a facing surface 359b and a facing surface 361b towards the second case 265 are continuous.

The circular arc surface 263a of the second case 263 and the circular arc surface having the facing surface 359a of the first case 359 and the facing surface 361a of the first case 361 have the same radius, i.e., R1. Also, the circular arc surface 265a of the second case 265 and the circular arc surface having the facing surface 359b of the first case 359 and the facing surface 361b of the first case 361 have the same radius, i.e., R2.

### Here, R1≠R2.

According to the above configuration, the pressing force pushing the pair of the first case 359 and the first case 361 to each other is generated over entire areas of the circular arc surface 263a of the second case 263 and the circular arc surface 265a of the second case 265.

According to the above configuration, since the first case 359 and the first case 361 can be integrated without using a screw, an effort is not required for the assembling. Further, when being assembled, the first case 359 and the first case 361 are not rotated.

### Sixth Illustrative Embodiment

A gearbox according to a sixth illustrative embodiment is described with reference to FIG. 13. FIG. 13 is a schematic view illustrating a pressing mechanism of a gearbox according to a sixth illustrative embodiment. This illustrative embodiment is different from the second illustrative embodiment as regards the second case, and the other configurations are the same. Therefore, the same parts as the second illustrative embodiment are denoted with the same reference numerals and the overlapping descriptions thereof are omitted.

In this illustrative embodiment, a second case 363 is formed with a pressing part 363a capable of abutting on an outer end surface of the first case 159 and a pressing part 363b capable of abutting on an outer end surface of the first case 161. Likewise, a second case 365 is formed with a pressing part 365a capable of abutting on the outer end surface of the first case 159 and a pressing part 365b capable of abutting on the outer end surface of the first case 161. Also, an interval a between the pressing part 363a and pressing part 363b of the second case 363 is set to be the same as an interval a between the pressing part 365a and pressing part 365b of the second case 365.

When the interval between the pressing part 363a and pressing part 363b of the second case 363 and the interval between the pressing part 365a and pressing part 365b of the second case 365 are denoted with ‘a’ and a height of the integrated first case 159 and first case 161 is denoted with ‘b’, it is set to be a<b.

When the second case 363 and the second case 365 are pressed in the direction of the integrated first case 159 and first case 161, the pressing part 363a and pressing part 363b of the second case 363 and the pressing part 365a and pressing part 365b of the second case 365 are elastically deformed and are pressed to hold the respective outer end surfaces (two surfaces of the pair of the first case 159 and the first case 161 intersecting with the pushing direction) of the integrated first case 159 and first case 161.

Therefore, the pressing part 363a and pressing part 363b of the second case 363 and the pressing part 365a and pressing part 365b of the second case 365 function as a pressing mechanism configured to push the pair of the first case 159 and the first case 161 to each other when the second case 363 and the second case 365 are pressed in the direction of the pair of the first case 159 and the first case 161.

According to the above configuration, since the first case 159 and the first case 161 can be integrated without using a screw, an effort is not required for the assembling.

### Seventh Illustrative Embodiment

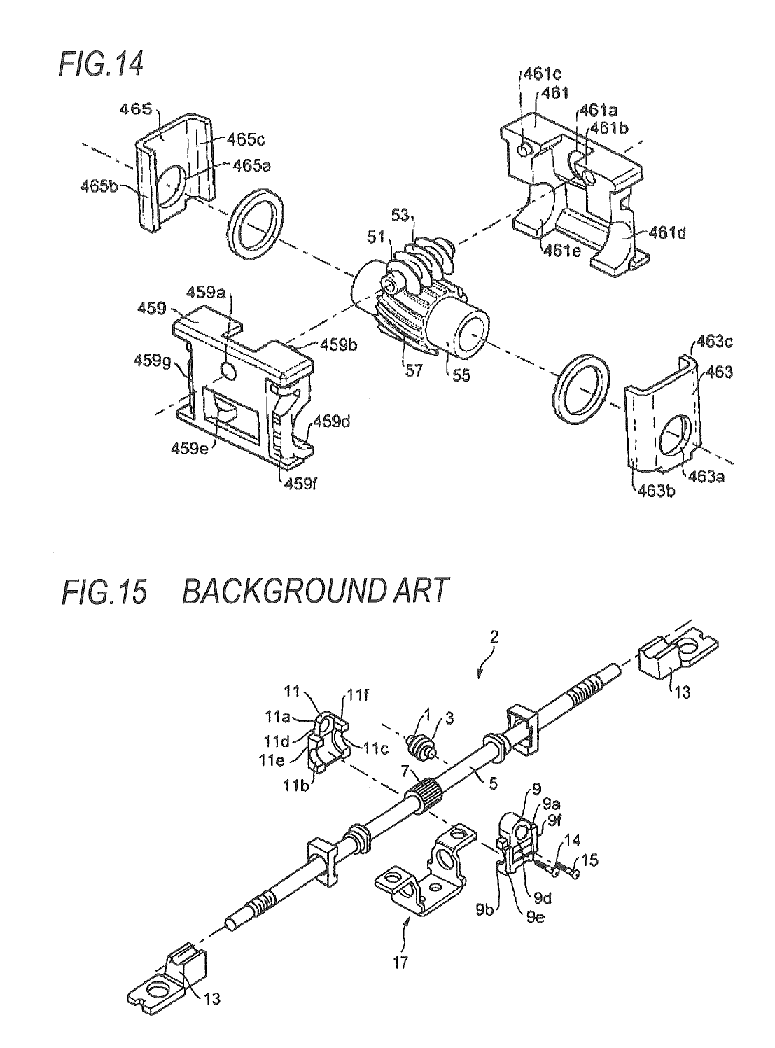

A gearbox according to a seventh illustrative embodiment is described with reference to FIG. 14. FIG. 14 is an exploded perspective view of a gearbox according to a seventh illustrative embodiment. In FIG. 14, the same parts as FIG. 1 showing the first illustrative embodiment are denoted with the same reference numerals and the overlapping descriptions thereof are omitted.

In FIG. 14, a pair of first cases 459, 461 is arranged to interpose the worm 53 therebetween from the axial direction. The first case 459 and the first case 461 are formed with a hole 459a and a hole 461a in which the drive shaft 51 is inserted and is rotatably supported.

A pair of second cases 463, 465 is arranged to interpose the worm wheel 57 therebetween. The second case 463 and the second case 465 are formed with a hole 463a and a hole 465a in which the driven shaft 55 is inserted and is supported. Meanwhile, in this illustrative embodiment, the first case 459 and the first case 461 are made of a resin. The second case 463 and the second case 465 are made of metal.

A surface of the first case 459 facing the first case 461 is formed with a protrusion 459b protruding towards the axial direction of the drive shaft 51 and a hole (not shown) with the hole 459a being positioned therebetween. In the meantime, a surface of the second case 461 facing the first case 459 is formed with a hole 461b, into which the protrusion 459b of the first case 459 is fitted, and a protrusion 461c protruding towards the axial direction of the drive shaft 51 and fitted into the hole of the first case 459 with the hole 461a being positioned therebetween. Meanwhile, the fitting of the protrusion 459b and the hole 461b and the fitting of the protrusion 461c and the hole are loose fittings. Therefore, the fittings are not to fix the first case 459 and the first case 461 each other but to temporarily position the same.

The surface of the first case 459 facing the first case 461 is formed at its lower part with semi-cylindrical recess portions 459d, 459e configured to interpose and support the driven shaft 55 from one side thereof. In the meantime, the surface of the first case 461 facing the first case 459 is formed at its lower part with semi-cylindrical recess portions 461d, 461e configured to interpose and support the driven shaft 55 from the other side thereof.

Both sides of the second case 463 are bent to form a bent part 463b and a bent part 463d configured to hold the first case 459 and the first case 461 therebetween. Likewise, both sides of the second case 465 are bent to form a bent part 465b and a bent part 465c configured to hold the first case 459 and the first case 461 therebetween.

The first case 459 is formed with a bead (a rib) 459f at a place on which the bent part 463b of the second case 463 abuts. The first case 461 is formed with a bead (a rib: not shown) at a place on which the bent part 463c of the second case 463 abuts.

The first case 459 is formed with a bead (a rib) 459g at a place on which the bent part 465b of the first case 461 abuts. The first case 461 is formed with a bead (a rib: not shown) at a place on which the bent part 465c of the second case 463 abuts.

When assembling the first case 459 and the first case 461, a length from a top surface of the bead 459f of the first case 459 to a top surface of the bead (not shown) of the first case 461 abutting on the bent part 463c of the second case 463 is set to be slightly longer than a length from an inner surface of the bent part 463b of the second case to an inner surface of the bent part 463c. Likewise, when assembling the first case 459 and the first case 461, a length from a top surface of the bead 459g of the first case 459 to a top surface of the bead (not shown) of the first case 461 abutting on the bent part 465c of the second case 465 is set to be slightly longer than a length from an inner surface of the bent part 465b of the second case to an inner surface of the bent part 465c.

In the meantime, the top surface of the bead 459f is a surface of surfaces of the bead 459f facing towards the axial direction of the drive shaft 51. Likewise, the top surface of the bead 459g is a surface of surfaces of the bead 459g facing towards the axial direction of the drive shaft 51.

When assembling the second case 463 and the second case 465 to the first case 459 and the first case 461, the bent part 463b and the bent part 463c of the second case 463 and the bent part 465b and the bent part 465c of the second case 465 can be assembled while elastically deforming the first case 459 and the first case 461, respectively.

Therefore, the bent part 463b and the bent part 463c of the second case 463 and the bent part 465b and the bent part 465c of the second case 465 function as a pressing mechanism configured to push the pair of the first case 459 and the first case 461 to each other when the pair of the second case 463 and the second case 465 are pressed in the direction of the pair of the first case 459 and the first case 461.

According to the above configuration, since the first case 459 and the first case 461 can be integrated without using a screw, an effort is not required for the assembling.

Although the present invention has been specifically described with reference to the specific illustrative embodiments, it is apparent to one skilled in the art that a variety of changes and modifications can be made without departing from the spirit and scope of the present invention.

The present application is based on Japanese Patent Application No. 2012-73130 filed on Mar. 28, 2012, the contents of which being here incorporated for reference.

### INDUSTRIAL APPLICABILITY

According to the present invention, the man-hour for assembling a component for which a mechanical coupling such as a screw is performed is not necessary. Therefore, a gearbox not requiring an effort for assembling is provided.

### DESCRIPTION OF THE REFERENCE NUMERALS

51: drive shaft (first shaft)

53: worm (first gear)

55: driven shaft (second shaft)

57: worm wheel (second gear)

59, 61: first case

59a, 61a: hole

63, 65: second case

63a, 65a: hole

63b, 63c, 65b, 65c: inclined surface (pressing mechanism)

1. A gearbox comprising:
a first shaft having a first gear;
a second shaft arranged to intersect with the first shaft and having a second gear configured to mesh with the first gear;
a pair of first cases arranged to interpose the first gear therebetween from an axial direction and formed with holes into which the first shaft is inserted;
a pair of second cases arranged to interpose the second gear therebetween from an axial direction and formed with holes into which the second shaft is inserted, and
a pressing mechanism in which the second cases, in response to pressing in a direction toward the first cases, press the pair of the first cases to each other.

2. The gearbox according to claim 1,
wherein the pressing mechanism comprises two pressing parts formed at the pair of second cases and configured to press the pair of first cases so as to hold therebetween.

3. The gearbox according to claim 1,
wherein the pressing mechanism comprises pressing force generation surfaces formed at the pair of second cases, and
wherein the pressing force generation surfaces are configured to generate a force component in a direction of pressing the pair of first cases to each other when the pair of first cases is pressed by the pair of second cases.

4. The gearbox according to claim 3,
wherein the pressing force generation surfaces are curved surfaces configured to press corner parts of the pair of first cases.

5. The gearbox according to claim 3,
wherein surfaces of the pair of first cases facing the pressing force generation surfaces of the second cases are circular arc surfaces, and
wherein the pressing force generation surfaces are circular arc surfaces configured to abut on the circular arc surfaces of the first cases and to have diameters smaller than those of the circular arc surfaces of the first cases.

6. The gearbox according to claim 3,
wherein the pressing force generation surfaces are inclined surfaces on which corner parts of the pair of first cases abut.

7. The gearbox according to claim 1,
wherein at least one of the first cases and the second cases is configured to be elastically deformed by a pressing force of the pressing mechanism, and then static friction between the first cases and the second cases, which is generated by an elastically repulsive force thereof, keeps an assembled state of the first cases and the second cases.

8. The gearbox according to claim 7,
wherein the first cases and the second cases have different degrees of elasticity.

9. The gearbox according to claim 7,
wherein a rib configured to be elastically deformed by the pressing force of the pressing mechanism is formed on a portion of the first cases, and the portion of the first cases abuts a bend part of the second cases.
